(19) United States
(12) Patent Application Publication
(10) Pub. No.: US 2019/0362391 A1
(43) Pub. Date: Nov. 28, 2019

(54) Digital Passive Advertising System and Method

(71) Applicants: Yakov Sadovsky, Herzliya (IL); Greg Salter, Modiin (IL)

(72) Inventors: Yakov Sadovsky, Herzliya (IL); Greg Salter, Modiin (IL)

(21) Appl. No.: 16/204,731

(22) Filed: Nov. 29, 2018

Related U.S. Application Data
(60) Provisional application No. 62/591,980, filed on Nov. 29, 2017.

(51) Int. Cl. G06Q 30/02; G09F 21/02; H04W 4/029; H04W 4/23

(52) U.S. Cl. CPC G06Q 30/0272; G06Q 30/0273; G09F 21/026; H04W 4/23; G06Q 30/0259; H04W 4/029; G06Q 30/0261

(57) ABSTRACT

A digital passive advertising display system and method where affiliates register to be “walking billboards”. Each affiliate can carry a display tag on their belongings such as on backpacks, or they can carry a larger display on their body. The tag or display is in radio contact with the affiliate's smartphone using a short range radio system such a BLUETOOTH™ or WiFi. A central system accepts location-based or global brand ads from advertisers and keeps track of the location of affiliates. Location-based ads based on an affiliate's location can then be pushed to his or her smartphone and hence to the display or tag. The thus affiliate displays the ad for passers-by to see. Affiliates can be compensated for carrying displays and displaying ads, and affiliates can sign up sub-affiliates.

This application is related to, and claims priority from, U.S. Provisional Patent Application No. 65/591,980 filed Nov. 29, 2017. Application 65/591,980 is hereby incorporated by reference in its entirety.

### BACKGROUND

### Field of the Invention

The present invention relates generally to digital advertising systems and more particularly to a passive advertising system where affiliates display ads from visible electronic displays to passers-by.

### Description of the Problem Solved

Location-based advertising is common with various ads and other information being pushed digitally to cellular telephones and other smart devices based on the location of the device. Various companies monitor the device location using GPS or Cell Tower information, or ads are pushed by short-range radio systems like BLUETOOTH™ or WiFi when a telephone or device is within range. Advertisers pay to have location-based ads pushed to the devices such as sales, specials and the like or simply global brands. The hope is that the device owner will respond to an ad which can be taken advantage of because the service offering the ad is typically located near the present location of the owner.

Local short-range or BLUETOOTH™ advertising is where ads are pushed to enabled smartphones, mobile devices or other digital devices within range of a radio source. This type of advertising is very short range and very local. Ads can also be pushed to devices from WiFi hot spots when a particular device enters the WiFi range. Central service based advertising is where a central service provider (like Google Corp. for example) tracks the location of enabled smartphones and devices and pushes ads to the device based on its location.

There are several disadvantages of these methods. First, in general, the device owner can opt-out or turn off incoming ads. Also, a device owner can in many cases choose to not share location information. Finally, the ads are targeted to a single person, the device owner but, in general, the device owner is to some extent an unwilling participant in the process and may not be the right person for the ad.

It is well-known that billboard advertising works well, especially if the billboard is well-placed and can be viewed long enough to read and understand its message. Sometimes this is done with multiple billboards with substantially the same ad at intervals along a highway placed so that a driver sees the same ad several times.

It would be tremendously advantageous to have a system and method where cooperative affiliates could carry advertising displays or advertising tags on their belongings that have location-based or global ads pushed to them based on their particular location. First, affiliates could earn money by carrying these devices, and second, a worn display, carried by a person, acts as a billboard that immediately attracts attention. It is almost impossible for a passer-by to not notice the display and read the ad.

### SUMMARY OF THE INVENTION

The present invention relates to a digital passive advertising display system and method. Under this system, affiliates register to be “walking billboards”. Each affiliate can carry a display tag on their belongings such as backpacks and the like, or they can carry a larger display on their body. The tag or display can be in radio contact with the affiliate's smartphone using a short range radio system like BLUETOOTH™, or the affiliate's display can be in direct contact with a WiFi hotspot.

In a central system embodiment of the invention, a central system accepts location-based or global brand ads from advertisers and keeps track of the location of affiliates by monitoring either their smartphones or their devices directly. This can be done with GPS or cell tower correlation or both. Location-based ads based on an affiliate's location can then be pushed to his or her smartphone and hence to the display or tag. In any case, the affiliate displays the ad for passers-by to see while in a predefined distance from the ad center (the nearby location that the ad relates to such as a store, restaurant or the like). The central service decides which ads to push to a particular affiliate based on their location.

In an alternative embodiment there is no reliance upon a central service. In this case, ads are pushed from a local ad originator directly to the affiliate's display, tag or smartphone using short range radio communication such as BLUETOOTH™ or WiFi. In this case, the range for receiving the ad is around 100-300 feet which is a typical BLUETOOTH™ or WiFi range. In this embodiment, the ads are pushed when the affiliate's display or smartphone pairs with a transmitting unit at the ad originator's site.

Affiliates can be paid directly for their time in carrying the display devices, or, more typically, can be paid or given points based on the number of responses to particular ads or both. In the present invention, the affiliate is willing participant benefiting from each ad displayed or responded to. The affiliate benefits by being compensated for carrying the display. The advertiser benefits because particular ads are being viewed by a much larger audience than by simply a particular cellphone owner, and the central service benefits by signing up advertisers and affiliates, and by distributing the ads.

### DESCRIPTION OF THE FIGURES

Attention is now directed to several drawings that illustrate features of the present invention.

FIG. 1 shows a diagram of an embodiment of the present invention.

FIG. 2 shows a diagram of an alternate embodiment of the invention.

FIG. 3 shows a tag display.

FIG. 4 is a flow chart of a particular way of executing the present invention.

Several figures and illustrations have been provided to aid in understanding the present invention. The scope of the present invention is not limited to what is shown in the figures.

### DESCRIPTION OF THE PREFERRED EMBODIMENTS

The present invention relates to a digital passive advertising system and method that allows willing affiliates to carry digital tags or advertising displays on either their bodies or their belongings. In one embodiment, a central service tracks the locations of affiliates and pushes location-based ads to these displays or tags either through the affiliate's smartphone or directly to the display. In an alternate embodiment, ads are received directly by a local radio connection such as BLUETOOTH™ when the affiliate's display or smartphone pairs with an advertiser's location. In this case, the ads are usually very local.

A digital display screen can be attached directly to the affiliate's body (such as on their back), or it can be attached to clothing or personal items such as a tag hanging from a belt or bag, placed on a backpack, or attached to a transportation vehicle such as a car, truck or bicycle. By becoming a “walking billboard” the affiliate directly benefits by being compensated either directly or indirectly, and both advertisers and consumers benefit by having location-based ads find more people who are interested in answering them. The present invention creates a revenue stream for the advertiser, for the affiliate, and for the central service that coordinates the system. It thus represents a win-win for all parties. Advertisers have a new place for ads based on locations, and affiliates receive compensation for simply passively displaying a tag or screen in plain sight.

The digital display can typically display a variety of images as opposed to a single photo or logo. Typical displays can be a slide show of images, advertisements, logos and any other type of visual or graphic ad. A display tag can be as small as a wallet-sized credit card, or it can be much larger such as a display worn on an affiliate's back or elsewhere.

While any type of display is within the scope of the present invention, a particular display can be a high-definition LCD screen. Optionally, the back of the screen can contain a QR code that can be used by others who may wish to become affiliates or initiate ads. Typically, the display can be in local short-range communication with the affiliate's smartphone using a technology such as BLUETOOTH™ or WiFi. If ads are originating from a central service, the central service communicates with the smartphone using the cellular provider's data channels, or by using WiFi when the phone is in range of a WiFi hot spot. A special application (App) in the user's smartphone allows the central service to push ads to the display. In the alternate embodiment, the affiliate's display or smartphone pairs with a similar device within range that then pushes one or more local ads.

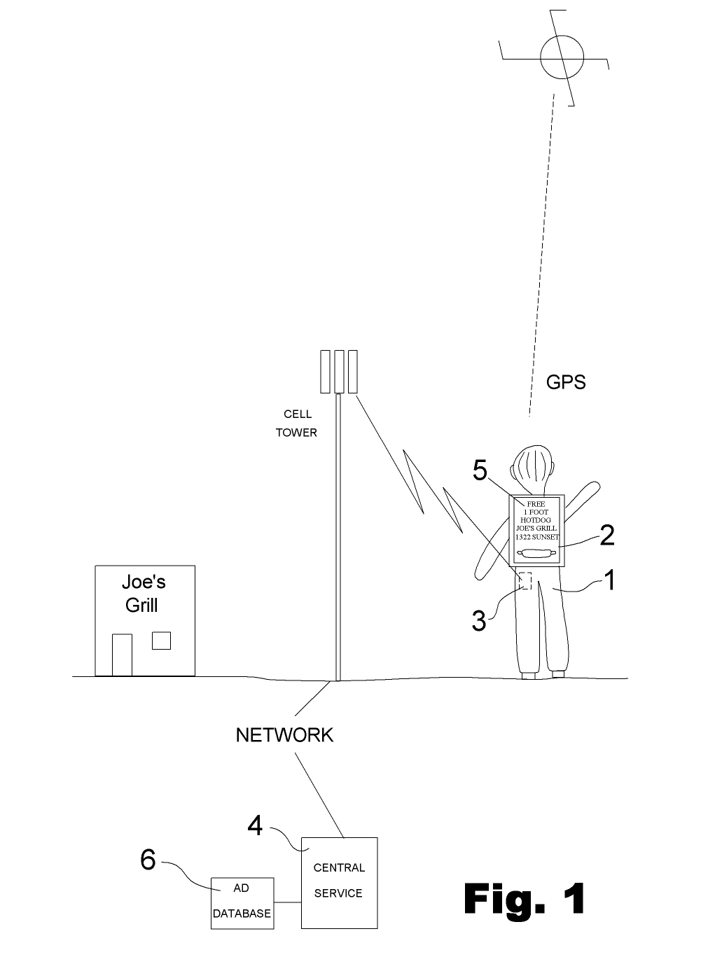

FIG. 1 shows a diagram of a central service embodiment of the present invention. An affiliate 1 carries a digital display 2 and a smartphone 3 or other mobile device. A central service 4 continually tracks the affiliate's location via GPS, cell tower correlation or by other means. Based upon the affiliates present location, ads 5 are pushed via cellular telephone system data channels or by WiFi connection to the smartphone 3. The affiliate's smartphone 3 is in local communication (BLUETOOTH™) with the display 2, and hence the ads are displayed. The central service 4 can continually update the ads 5 as the affiliate 1 moves around. The ads 5 can be a mix of location-based ads and global brand ads. In this case, even when the affiliate 1 is not near any location-based ad center, global ads can still be displayed. Such global ads can be brand ads (like a well-known soft drink), or they can be informational ads or event ads such as a special production that will appear at a local theater. As the affiliate approaches a new ad center, relevant local ads 5 can be displayed. Multiple ads can be displayed on larger displays, and on smaller tag displays, sequences of different ads can be played. The smartphone 3 or display 2 can also have access to “canned” ads that are stored in the device for use whenever the affiliate 1 loses communication with the central service 4. Ads are typically supplied to the central service 4 from an ad-server or ad database 6.

The display 2 typically contains a processor and memory with a set of stored instructions that reside in the memory and execute on the processor. The memory can also store data such as both dynamic and canned ads as well as location data. As stated, in the absence of a signal from the central service 4, canned ads can be retrieved from the memory and displayed.

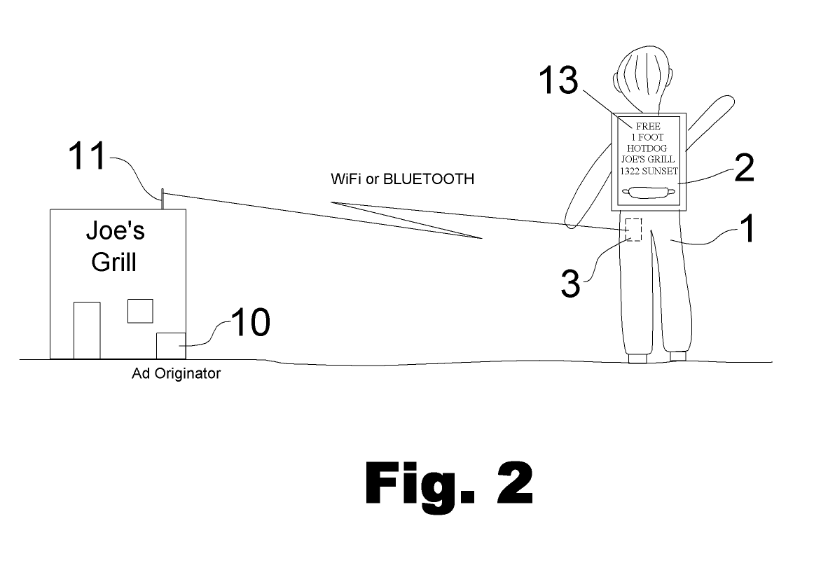

In the alternate embodiment of the present invention, the central service only serves to enroll affiliates, compensate them and set up local ad sources. FIG. 2 shows a block diagram of this embodiment. An ad center 10, which can be a store, restaurant or any other type of location offering a service or product, has on premises a short-range transmitter 11 such as a BLUETOOTH™ device. This can be as simple as a smartphone, or it can be a WiFi hotspot transceiver or other communications device. The affiliate 1 carries a display 2 which can be in local communication with the affiliate's smartphone 3, or it can directly pair with the short range transmitter or WiFi transceiver. Ads 13 are pushed (or pulled), when the affiliate's smartphone 3 or display 2 pairs with the ad center 10. When the affiliate 1 moves out of range of the ad center 10, the display can optionally revert to displaying “canned” or pre-stored ads which can be global brand ads or event ads or the like.

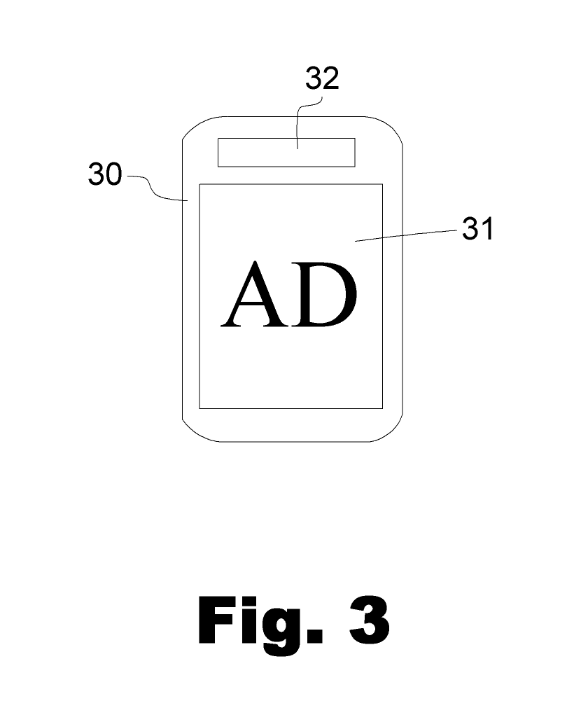

FIG. 3 shows a typical tag type display that can be attached to personal items. A card 30 approximately the size of a credit card or slightly larger contains a display 31. Within the card 30 electronics 32 drives the display and provides short-range communications using a technique like BLUETOOTH™. This card 30 can contain a battery and is free-standing or rechargeable. It can pair with an affiliate's smartphone to receive ads. Typically, it is a sealed card that can be discarded eventually after the battery has expired or can be re-used once recharged and reconnected to the central system. As an example of such a tag or card display, the following dimensions are preferred: The screen can be the size of most credit cards or approximately 85.60 mm×53.98 mm (3.370 in×2.125 in) with rounded corners having a radius of 2.88-3.48 mm. This is the same size as ATM cards and other payment cards such as debit cards. The card can include a 2.8 inch TFT LCD module with touch screen 240*320 RGB 36 PIN. The card or tag fits into any basic ID card holder, badge holder or business card holder. It should be noted that the dimensions given are for example only—any size card, tag or display is within the scope of the present invention.

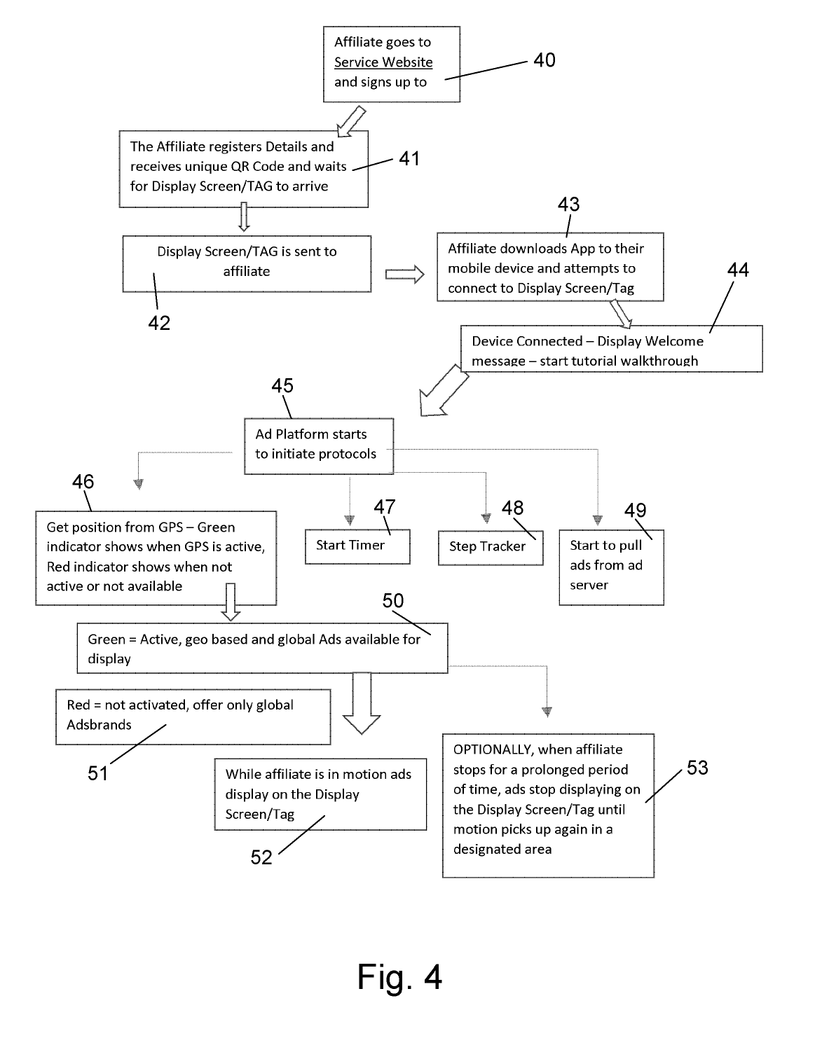

FIG. 4 shows a global flow chart of the embodiment of FIG. 1. To start 40, an affiliate goes to a service website and registers 41. The affiliate activates and account, typically receives a QR code. A dashboard on the website allows the affiliate to view and manage his or her account at any time. A shipment of a display device or tag to the affiliate is initiated, and the device is sent 42 to the affiliate. Upon receiving the device, the affiliate downloads 43 a special APP from the website or from an App store to their smartphone. Upon activation, the APP activates the tag or display using short-range communications like BLUETOOTH™. When the display device pairs or connects 44, a welcome message is displayed, and a tutorial can be provided to orient the affiliate.

The affiliate is now ready to begin work. When the affiliate wants to begin to display ads, he or she simply activates the App on their smartphone (or sends a message to the central station via the App). A central station or Ad Platform initiates communication 45 with the smartphone. At central station continually attempts to find and track the location or position 46 of the affiliate using GPS or other features on the smartphone. The central station can start a timer 47 to keep track of the amount of time spent by the affiliate working, step a tracker 48 to continually track the affiliate and start to continually pull ads 49 from a Ad Server.

The central station may lose tracking on an affiliate. Thus, the affiliate may be classified as “green” or location known 50 or “red” or location unknown 51. If the location is known 50, location-based ads can be pushed to the affiliates smartphone and hence display. If the location is unknown 51, typically only global brand ads, announcements and the like are pushed.

Optionally, when the location is known 50, the affiliate's motion can be determined. If the affiliate is in motion 52, ads can be displayed. Again optionally, if the affiliate stops for a predetermined time 53, pushing ads can be halted and either a fixed display shown or no display at all. When the affiliate decides to quit working (displaying ads), he or she can 1) send a message to the central station via the App, or 2) simply disable (kill) the App on their smartphone.

There are many different ways to compensate affiliates from direct payments for time to the accrual of points. Generally, affiliates are more likely to be attracted if they know they are earning real money for their time. The money can be based on ads responded to by others; however, this requires tracking a particular ad and response and making sure that a particular affiliate displayed that ad. The display of the ad and the response to it by a third party should be within a short time. It is impossible to track response to global ads. Hence, some form of direct compensation as well as bonuses for ad response may be necessary.

Optionally, affiliates can also recruit others as sub-affiliates in a tree fashion in some embodiments of the invention. Here an affiliate can directly benefit for a period of time from successful ad responses or work by sub-affiliates. Sub-affiliates are generally registered by the affiliate himself or herself rather than directly. This allows the system to successfully create and manage the tree of sub-affiliates.

### SUMMARY

The following is a bullet point summary of features of the present invention.

### Platform:

A central station registers affiliates and manages a backend ad-server that stores images as ads from clients seeking to advertise.
Affiliates are people who wish to earn money by displaying ads to the public.
Affiliates have an App on their mobile device in wireless communication with the central station.
The mobile device is in wireless local communication with a tag or display.
The App wirelessly sends image ads to the tag or display.
Depending on affiliate's geographic location, the image ad on the display adjusts accordingly.

### Affiliates:

People who want to make some extra side money sign up/register as an affiliate on a control website.
Once registered they will receive a tag or display unit which they will carry and display.
If the initial handshakes between the tag or display, the display App and the central station are successful, the affiliate will see an image ad displayed on their display.
As the affiliate moves around a populated environment, they will earn funds to their account which can later be withdrawn once a payout target goal is reached. Displayed ads can be based on the affiliate's location or can be global.

### Clients:

Clients are those who are seeking to advertise by combining online image display advertising with offline digital billboard technology.
Clients have a choice of various packages to choose from that include options based on number of presumed views and duration of the campaigns.
Clients typically provide images for use in the ad campaign that they approve.
Images are uploaded to the ad-server and distributed through the platform via the App on affiliate's mobile device.
Ads are displayed on the affiliates tag or display.

The present invention provides a system and method for using affiliates as “walking billboards”. Affiliates earn money this way, and advertisers manage to reach a much larger audience for both location-based ads and global ads then simply pushing them onto single mobile devices or putting up fixed billboards.

In some embodiments of the present invention, affiliates can partially or totally control what ads they are displaying by entering date into the smartphone which is conveyed to the central station. In some embodiments, the affiliate may request a particular ad or set of ads to be displayed. This is useful, if a consumer asks to repeat a particular ad, or if the affiliate determines that he or she is in a location where a particular ad is appropriate.

Several descriptions and illustrations have been presented to aid in understanding the present invention. One with skill in the art will realize that numerous changes and variations may be made without departing from the spirit of the invention. Each of these changes and variations is within the scope of the present invention.

We claim:

1. A system for digital display advertising comprising:
a central station that includes a server, an ad database, and network communication capability;
at least one portable display device worn or displayed by an affiliate, the portable display in short-range communication with a cellular telephone carried by the affiliate;
an application (app) comprising executable computer instructions that executes on the smartphone, the application allowing the central station to push ads from the ad database through the smartphone and display them on the portable display device;
the central station configured to track a geographic location of the affiliate and push location-based ads when said geographic location is known;
the central station configured to push global ads when said geographic location is not known.

2. The system of claim 1 wherein the smartphone communicates said geographic location to the central station over the network.

3. The system of claim 2 wherein the network is a cellular network.

4. The system of claim 2 wherein the network is a WiFi network.

5. The system of claim 1 wherein the affiliate is compensated for time spent displaying ads.

6. The system of claim 1 wherein the affiliate wears the portable display device.

7. The system of claim 1 wherein the ads pushed by the central station can be changed by the affiliate.

8. The system of claim 7 wherein the affiliate can change the ads being displayed by requesting a particular ad from the central station.

9. The system of claim 1 wherein affiliates are registered into a database at the central station.

10. The system of claim 1 wherein the central station is a business location.

11. The system of claim 10 wherein the display device displays particular ads from the business location when the affiliate is in range of the business location and displays general ads when the affiliate is not in range of the business location.

12. A method of advertising comprising:
allowing an affiliate to register on a system webpage;
shipping a display device to the affiliate;
allowing the affiliate to download an application onto a smartphone from a central location;
allowing the affiliate to activate the application;
determining geographic location of the smartphone;
pushing localized ads to the smartphone from the central location based on the geographic location of the smartphone;
allowing the display device to display the ads.

13. The method of claim 12 further comprising keeping a record of time spent by the affiliate displaying ads.

14. The method of claim 13 further comprising compensating the affiliate for the time spend displaying ads.

15. The method of claim 12 further comprising changing the ads pushed to the smartphone based on the geographic location of the affiliate.

16. The method of claim 12 wherein the affiliate wears the display device.

17. A system for digital display advertising comprising:
a central station that includes a server, an ad database, and network communication capability;
at least one portable display device worn by an affiliate, the portable display in short-range communication with a cellular telephone carried by the affiliate;
an application (app) comprising executable computer instructions that executes on the smartphone, the application allowing the central station to push ads from the ad database through the smartphone and display them on the portable display device.

18. The system of claim 17 wherein the smartphone communicates a geographic location of the affiliate to the central station over the network.

19. The system of claim 18 wherein the central station changes ads being pushed to the smartphone based on the geographic location of the affiliate.

20. The system of claim 17 wherein the network is either a cellular network or a WiFi network.
